(19) United States
(12) Patent Application Publication
(10) Pub. No.: US 2026/0260234 A1
(43) Pub. Date: Sep. 3, 2026

(54) CRYPTO CURRENCY HARDWARE WALLET

(71) Applicant: MatterFi, Sheriden, WY (US)

(72) Inventors: Michal Pospieszalski, West Hollywood, CA (US); Christopher Odom, Austin, TX (US)

(73) Assignee: MatterFi, Sheridan, WY (US)

(21) Appl. No.: 19/551,596

(22) Filed: Feb. 26, 2026

Related U.S. Application Data
(62) Division of application No. 17/300,944, filed on Dec. 15, 2021, now abandoned.
(60) Provisional application No. 63/181,221, filed on Apr. 28, 2021.
(60) Provisional application No. 63/125,947, filed on Dec. 15, 2020.

(51) Int. Cl. G06Q 20/38; G06Q 20/36

(52) U.S. Cl. CPC G06Q 20/3829; G06Q 20/36

(57) ABSTRACT

A crypto hardware wallet comprising a smart card with a network computer interface. The smart card receives a counterparty public key through the network computer interface, computes a shared secret based on the received counterparty public key, generates addresses specific to the counterparty based on the computed shared secret, and signs transactions using the generated addresses. The smart card may obtain a BIP 47 identity and process transactions using the identity. The smart card may select a seed for computing the shared secret based on a card seed index, where the smart card stores a plurality of independent seeds.

### CROSS-REFERENCE

This application is a divisional of U.S. Patent Application No. 17/500,944, filed Dec. 15, 2021, which claims the benefit of U.S. Provisional Application No. 63/125,947 titled "CRYPTO CURRENCY HARDWARE WALLET," filed Dec. 15, 2020, and U.S. Provisional Application No. 63/181,221 titled "SECURE CRYPTOGRAPHIC SERVER CARD," filed Apr. 28, 2021, all of which are hereby incorporated by reference in their entirety.

### BACKGROUND INFORMATION

Current Crypto wallets that store crypto currency by storing private cryptographic keys are difficult to use and come in formats unfamiliar to most users who commonly use credit cards and debit cards for their transaction. In addition, crypto wallets have been shown to be vulnerable to attack and loss of sensitive data.

The current technical approach to the hardware and software processing of sensitive security functions (for example financial transactions) on crypto wallets have been compromised by finding software exploits or there are even proposed physical attacks that send low level Integrated circuit commands on communication port of the individual IC chips that make up the crypto hardware wallet.

What is needed is a crypto hardware wallet that can store crypto currency and has critical security functionality implemented in a convenient but secure single functioning system that can be easily integrated into many different form factors, especially familiar form factors such as smart cards, cell phones and computing devices.

### SUMMARY OF THE INVENTION

The crypto hardware wallet system with a secure crypto processing environment and a secure transaction authorization device. Where the secure crypto processing environment is on a single die IC with encrypted memory that holds an encrypted entry that has sensitive data. An encryptor/decryptor is coupled to the encrypted memory and decrypts the encrypted entry using an internal security mechanism. A micro controller unit coupled to the encryptor/decryptor requests and receives the sensitive data. The micro controller unit receives a request and uses the sensitive data to fulfill the request. The internal security mechanism may include an internal cryptographic key derived from a micro radiation source. The secure transaction authorization device may include a secure computing environment and a user experience device coupled to the secured computing environment via a switch. Where the secure computing environment controls whether the user experience device is communicating to the secured processing environment.

### BRIEF DESCRIPTION OF THE DRAWINGS

FIG. 1 illustrates a secure crypto transaction environment.

FIG. 2A illustrates a block diagram of a crypto wallet system.

FIG. 2B illustrates a potential Point of Sale embodiment of the crypto wallet system.

FIG. 2C illustrates a potential wired cell phone embodiment of the crypto wallet system.

FIG. 2D illustrates a potential wireless cell phone embodiment of the crypto wallet system.

FIG. 3 illustrates a potential process flow showing the usage of the crypto wallet system.

### DETAILED DESCRIPTION

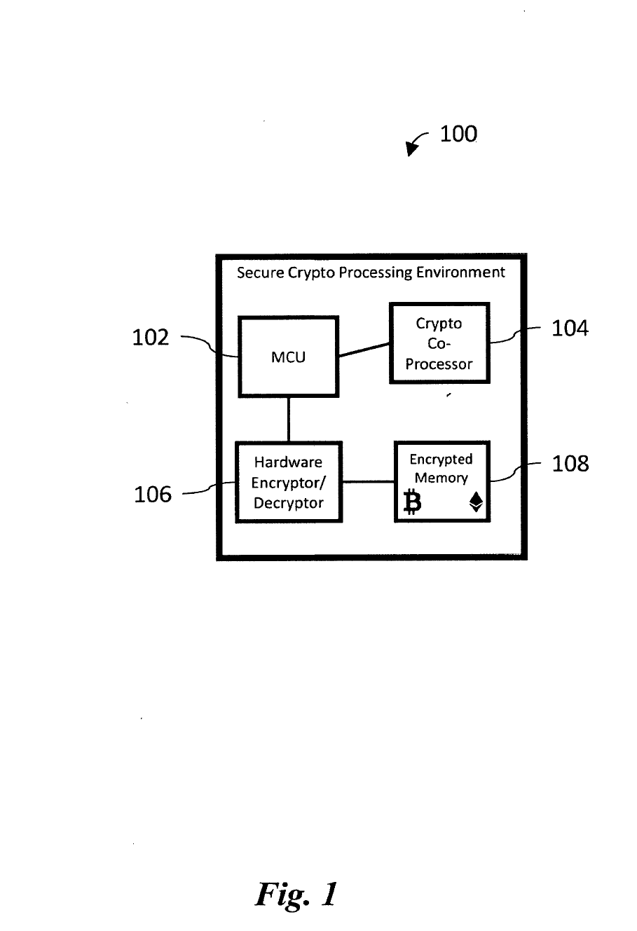

FIG. 1 Illustrates a secure crypto processing environment 100. The secure crypto processing environment 100 may be implemented on multiple integrated circuit chips, a single integrated circuit or a single die of an integrated circuit.

The secure crypto processing environment 100 may include a micro controller unit (MCU) 102, a crypto co-processor 104, an hardware encryptor/decryptor 106 and encrypted memory 108.

The micro controller unit 102 may have a secure enclave and the secure enclave may implement the crypto co-processor 104 and the hardware encryptor/decryptor 106. The micro controller unit 102 may be locked and not be updatable, for example the micro controller unit 102 may be a single burn PROM or ROM or other technology that is not physically updatable. The micro controller unit 102 may be restricted to only be updated by cryptographically proven (for example, private key signed) software content updates.

The crypto co-processor 104 implements crypto functionality. Since the crypto co-processor 104 is not easily updatable (if updatable at all) it would be preferred the crypto co-processor 104 implements crypto functions that are well establish or are not expected to change significantly over time. The crypto co-processor 104 may be used to speed up the processing of crypto currency transactions.

The encrypted memory 108 may store private keys. The private key may be the keys used for signing crypto currency transactions.

Secure crypto processing environment 100 may support crypto algorithm protocols such as Blake and Open Transactions or other crypto currency protocols and the algorithms used by such protocols. The secure crypto processing environment 100 may support signing of related transactions in protocols such as Open Transactions.

The Secure crypto processing environment 100 via the micro controller unit 102 or the crypto co-processor 104 may access the internet directly for certain functionalities, for example obtaining BIP 47 identities (Bitcoin Improvement Proposal #47) or the Open Bitcoin Privacy Project (OBPP), for example OBPP Version 5 (OBPP-5) (github.com/OpenBitcoinPrivacyProject/ rfc/blob/master/obpp-05.mediawiki).

The micro controller unit 102 and crypto co-processor 104 may directly interface with hardware input/output devices, for example Bluetooth, cameras for scanning QR codes, etc. In such cases those hardware input/output devices may be un-updatable or treated as untrustworthy by the micro controller unit 102 and crypto co-processor 104.

The hardware encryptor/decryptor 106 may be hardware based. The hardware encryptor/decryptor 106 may use an internal security mechanism for reading and writing sensitive data to the encrypted memory 108. Sensitive data may be a single number, a set of numbers or other alphanumeric data or other patterns of one and zeros representing any type of information. The internal security mechanism may use an internal cryptographic key, also known as a hardware cryptographic key or internal key. The internal cryptographic key may be asymmetric or a symmetric key pair. The internal cryptographic key pair may have been generated from hardware derived entropy. The hardware derived entropy may come from a micro radiation source. The internal symmetric key pair may be uniquely set at the time of manufacture. If the secure crypto processing environment 100 is broken or tampered with the hardware encryptor/decryptor 106 may destroy the internal cryptographic key used in decrypting the encrypted memory 108.

The hardware encryptor/decryptor 106 may be difficult to tamper with for example with the hardware encryptor/decryptor 106 being made in a single die IC (Integrated Circuit).

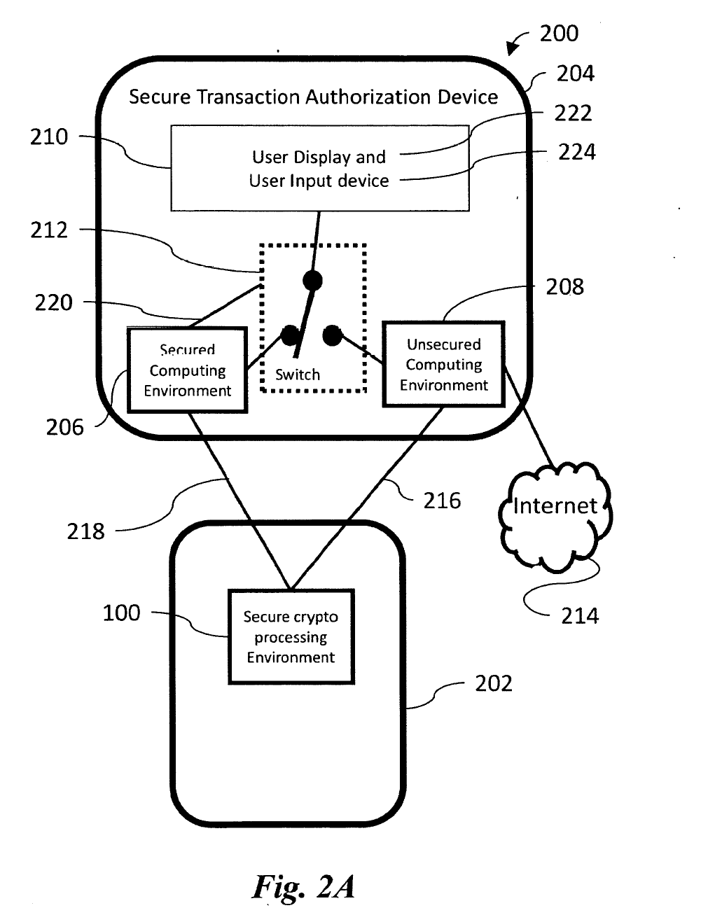

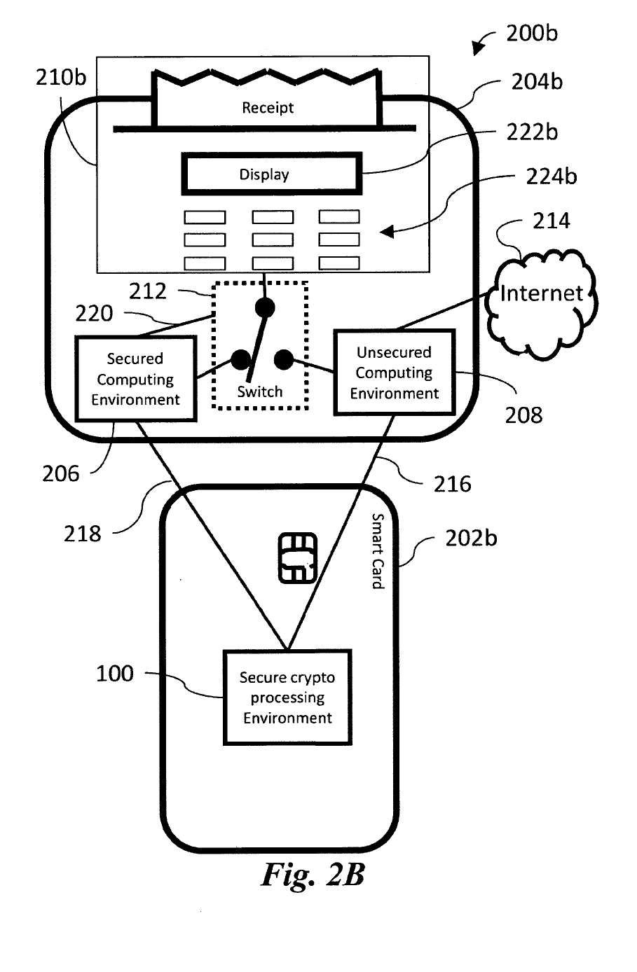

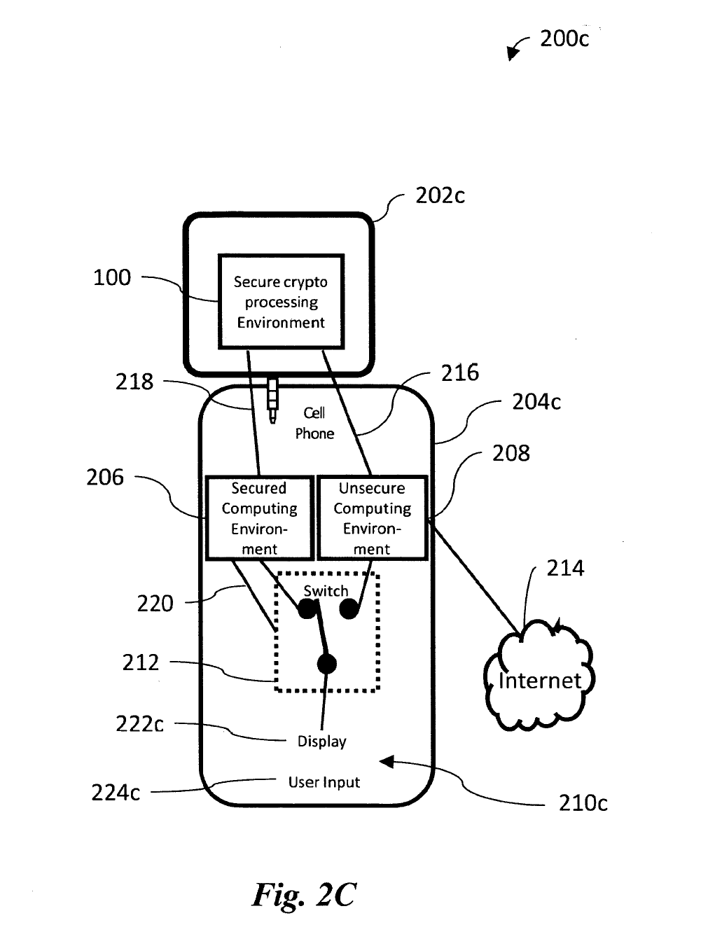

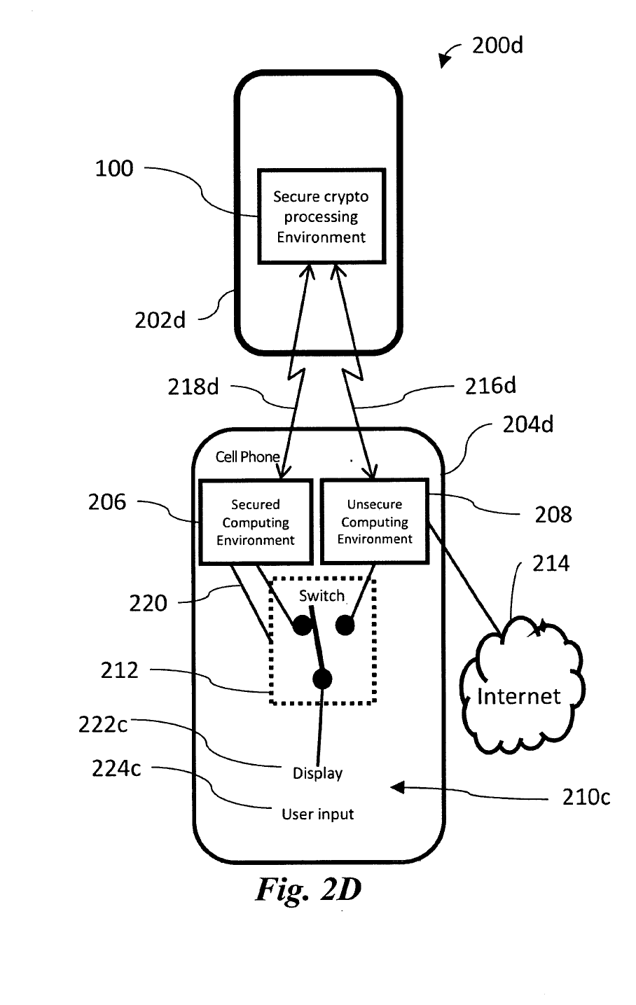

FIG. 2A illustrates a block diagram of a crypto wallet system 200.

The crypto wallet system 200 is shown with a crypto wallet 202 and a secure transaction authorization device 204. The crypto wallet system 200 may integrate the crypto wallet 202 and the secure transaction authorization device 204 in one physical unit.

The crypto wallet system 200 may securely store sensitive data like crypto currency information in the encrypted memory 108, and may provide secure authorization of transactions using the stored crypto currency information.

The crypto wallet system 200 may securely store other sensitive data in addition to crypto currency information and protect that sensitive data via the internal cryptographic key. For example, the other sensitive data may be private information. The sensitive data may be crypto currency information.

The crypto wallet 202 includes the secure crypto processing environment 100. The crypto wallet 202 may be in many forms. The crypto wallet 202 may be a separate physical hardware device or incorporated into a larger device. The separate physical hardware device may be in a familiar form factor such as a debit/credit card with a chip and pin interface, a smart card, a USB thumb drive, a Bluetooth enabled key fob or in number of formats for example as a small insertable concealable device. The separate physical hardware device may communicate wirelessly, for example over short distance wireless communication like Bluetooth, near field communication (NFC), Wi-Fi or other wireless communication means. The crypto wallet 202 may be incorporated into a larger device such as a smart phone, personal computer, car, purse or other devices that a person may want to carry crypto currency on or store private information on.

The secure transaction authorization device 204 may include a secured computing environment 206, an unsecured computing environment 208, a user experience device 210, a switch 212, a network connection 214, an unsecured conduit 216, and a secured conduit 218. The secure transaction authorization device 204 may be implemented into anything including vehicles and other consumer devices.

The switch 212 may connect the user experience device 210 to the secured computing environment 206 or the switch 212 may connect the user experience device 210 to the unsecured computing environment 208. The secured computing environment 206 may control the switch 212, for example through connection 220, and determine if the user experience device 210 is controlled by the secured computing environment 206 or the unsecured computing environment 208.

The user experience device 210 may include a user display 222 and a user input device 224. The user experience device 210 may talk directly to the secure crypto processing environment 100 and in this configuration the crypto wallet system 200 may not have the secured computing environment 206.

The user display 222 may be a cell phone display screen, a screen, a screen on a payment processing terminal, an LCD panel, or anything capable of conveying information to a user including for example a speaker or other means.

The user input device 224 may be a keyboard, a touchpad, a cell phone touch screen, input button, microphone, mouse, fingerprint reader, or anything that enables input to be gathered from a user. The user input device 224 may be unalterable.

The secured computing environment 206 may send requests/replies to and from the user experience device 210 and the micro controller unit 102 via the secured conduit 218. The secured computing environment 206 may be trusted by the crypto wallet 202 through various means, for example providing the requests are signed by a trusted private key or only if the communication comes via the secured conduit 218 that may be secured by various means such as cryptographically or physically.

The scrypto wallet system 200 protects the sensitive data by first encrypting the sensitive data at rest (i.e., storing it in the encrypted memory 108) and second to unencrypt the stored sensitive data only the secure environment 100 may be used and the secured computing environment 206 may act as part of a standard user authorization process (for example a PIN) while the internal cryptographic private key is still intact in the hardware encryptor/decryptor 106.

The crypto wallet system 200 may sign off-chain transactions for example signing open transaction standard (opentxs) transactions by using the secured conduit 218. The opentxs transaction may be signed by making a request over secured conduit 218 to the crypto wallet 202 and the crypto wallet 202 may sign with a private key. The crypto wallet system 200 may sign on-chain and off-chain transactions with reusable payment codes as defined in Open Bitcoin Privacy Project-5.

The crypto wallet 202 may use hierarchical deterministic key derivation of public key encryption keys with secp256k1 and ed25519. The derivation of the public keys may be from a single seed as described in bitcoin Improvement Proposal 32 (BIP-32) for secp256k1 or BIP32-ed25519 for ed25519.

When a security key operation is requested the target key maybe specified by HD BIP-32 path and a tweak value (which may be zero). The tweak value is the same as the argument of the same name in the secp256k1_ec_seckey_tweak_add and secp256k1_ec_ pubkey_tweak_add functions from libsecp256k1.

The crypto wallet 202 may respond to different cryptographic requests (also known as cryptographic operations). Parameters for the cryptographic operations may use different parameters once a seed (i.e., private key) has been initialized. When the initialization the seed is created it may be output to the software wallet one time so the user has the option to record the seed.

The crypto wallet 202 may derive the derived public keys from the seed. The crypto wallet 202 does not need to maintain copies of the derived public keys as the derived pubic keys can be regenerated at any time so long as the request is repeated with the same accompany parameters.

The crypto wallet 202 may respond to a request to return if there is available room for another seed to be stored on the crypto wallet 202. This “IsThereRoomForAnotherSeed()” request may be requested first to confirm that there is room before a new seed initialization is attempted.

The parameters that any requests to the crypto wallet 202 contain may include a card seed index, a HD path, a tweak, a curve, a counterparty public key, and a hash.

The card seed index is an integer specifying which of the available seeds in the card to use. For example, the first seed (i.e., private key) put on the card may be accessed by specifying the card seed index of zero. The second seed would be access using the card seed index of one.

The HD path is the Hieratical Deterministic path as specified in BIP-32. For example, the first child of the master seed key may have a HD path of “m/0”, and the fifth child of that child key may have a HD path of “m/0/4”.

The tweak is the value as specified in the secp256k1_ec_seckey_tweak_add and secp256k1_ec_pubkey_tweak_add functions from libsecp256k1. The tweak value may be zero.

The curve specifies elliptical curve used in calculating the derived keys, for example reference the curve as specified in public key implementation secp256k1 or ed25519.

The counterparty public key, the destination “address” that only the system with the corresponding private key will be able to further spend the crypto currency.

The hash is the payload to sign. The payload would be signed base on the transaction seed at the card seed index, or a derived public key derived from the seed at the card seed index and the other parameters accompanying the request.

The crypto wallet 202 may respond to a request for a extended public key generation (also known as xPub computation), an xPub computation request. The xPub computation request may be accompanied by inputs parameters such as the card seed Index, the HD path, the tweak, and the curve. The xPub computation request may return the derived Extended Public Key

The crypto wallet 202 may respond to a request for a cryptographic signing (also known as signing). The signing request may be accompanied by input parameters such as the card seed index, the HD path, the tweak, the curve, and the hash. The signing request may return a cryptographic signature of the hash using a number (aka cryptographic private key). The crypto graphic private key may be based on the seed at the card seed index and the other parameters that accompany the signing request. The signing process may authorize both on chain and off chain (for example, Open Transactions) transactions.

The crypto wallet 202 my respond to a request for an Elliptic Curve Diffie–Hellman Key Exchange (also known as ECDH shared secret computation). The ECDH shared secret computation may be accompanied by input parameters such as card seed index, HD path, Tweak, Curve, Counterparty Public Key. The ECDH share secret computation may return a shared secret as an elliptic curve point. The elliptic curve point may return the x value or both the x value and the y value.

The crypto wallet 202 may respond to request to Initialization (n word count) returning a n word seed phrase.

The crypto wallet 202 may respond to a request to check if the crypto wallet 202 is empty, that is there are no seeds currently set on the crypto wallet 202.

The security functionality maybe spread among various components of the crypto wallet system 200, for example the secure crypto processing environment 100, the secured computing environment 206, the secured conduit 218.

Updates to the security functionality may not be allowed. Updates to the security functionality may only be done in a highly secured manor. The crypto wallet system 200 may not have update restriction for non-security functions, thus making it easier to modify the crypto wallet system 200 to be more adaptable and user friendly, but still maintaining preexisting security levels.

The network connection 214 may provide connectivity to the internet via various types of wired and wireless network technology for example Bluetooth, Wi-Fi, cellphone cell tower networks, satellites or any other networking technology that will enable the crypto wallet system 200 to communicate with other computing devices. The network connection 214 may provide internet access to the micro controller unit 102.

The unsecured conduit 216 and the network connection 214 may enable the micro controller unit 102 and crypto co-processor 104 to communicate with the internet.

The unsecured computing environment 208 may execute applications that make requests for cryptographic processing on the crypto wallet 202 via the unsecured conduit 216. The unsecured computing environment 208 and the applications that run on it may be updateable, for example online via a user or application developer.

The unsecured computing environment 208 may run any number of applications desired in a rich graphic format and simply rely on the crypto wallet 202 to securely provide cryptographic functionality in the application for the user.

The secured computing environment 206 may be implemented via either hardware or on a micro controller unit whose software cannot be updated or altered. The secured computing environment 206 software may be updateable by some highly secure scheme.

When the user needs to confirm a transaction the secured computing environment 206 disables the unsecured computing environment 208 via the switch 212 and confirms the transaction with the user via direct access to the user experience device 210. This may be implemented in hardware and be un-alterable.

The secured computing environment 206 may filter the unsecured computing environment 208 or entirely censor the unsecured computing environment 208’s access to the user experience device 210 via the switch 212 or other suitable means.

The micro controller unit 102 and crypto co-processor 104 may consider all input from the user experience device 210 as untrustworthy, in which case the crypto wallet system 200 may employ additional security mechanisms, such as a PIN that is only recorded in crypto wallet 202 and if entered into the user experience device 210 and sent with the input then the input may be trusted. 2

The user experience device 210 may receive input (for example a personal identification number, PIN) or receive other reliable input to verify a user has access to unlock the crypto signing functionality of the crypto wallet 202.

Copies of the sensitive data stored on the crypto wallet 202 may be made in specific secure scenarios for purposes of backup and recovery, thus rendering the crypto wallet 202 disposable.

A private key stored on the crypto wallet 202 may be backed up by a deterministic key generation algorithm that relies on an easily human referenced id such as the “mnemonic code words” as specified in BIP-39.

The crypto wallet 202 may respond to a panic pin to completely wipe the crypto wallet 202. The panic pin may be used by a user instead of an actual pin in a situation where they don’t want to unlock the crypto signing functions but instead want to remove access to the funds on the crypto wallet 202.

The micro controller unit 102 and secured computing environment 206 may be software upgradable by a trusted source, for example by the manufacturer so long as that software upgrade process is tamper proof and cryptographically secure.

The crypto wallet system 200 has the security critical functionality implemented on the crypto wallet 202, for example a smart card, as opposed to separate components, which allows for many different ‘hardware wallet’ integrations. The crypto wallet system 200 allows the hardware and software processing security sensitive functionality to be in a single integrated circuit die, thus providing a microscopic footprint for physical attack. Storing private keys on the hardware wallet that is a familiar form factor such as a smart card gives users an easy way to manage their money and use different devices for their transactions. Separating the unsecure computing environment 208 from the secured computing environment 206 allows for rich, updatable applications that still perform reliably high security functionality for sensitive data interaction with the user.

FIG. 2B illustrates a potential point-of-sale embodiment 200b of the crypto wallet system 200 showing a smart card 202b, a point-of-sale device 204b, a point-of-sale user input/output section 210b, a point-of-sale display 222b and point-of-sale input buttons 224b.

The smart card 202b is an embodiment of the crypto wallet 202. The point-of-sale device 204b is an embodiment of secure transaction authorization device 204.

The point-of-sale user input/output section 210b is an embodiment of the user experience device 210.

The point-of-sale display 222b is an embodiment of the user display 222.

The point-of-sale input buttons 224b is an embodiment of the user input device 224.

The unsecured conduit 216 is shown directly connection between the unsecured computing environment 208 and the secure crypto processing environment 100, but in detail those communications would occur through the chip and pin interface on the smart card 202b.

The secured conduit 218 is shown directly connection between the secured computing environment 206 and the secure crypto processing environment 100, but in detail those communications would occur through the chip and pin interface on the smart card 202b.

FIG. 2C illustrates a potential wired cell phone embodiment 200c of the crypto wallet system 200, with a wired smart phone 204c and a square external attachment 202c.

The wired smart phone 204c is an embodiment of the secure transaction authorization device 204.

The square external attachment 202c is an embodiment of the crypto wallet 202. The square external attachment 202c may plug into a receptacle on the wired smart phone 204c, for example an audio jack, a USB plug, a lightening plug or other plugs on the wired smart phone 204c.

The unsecured conduit 216 is shown directly connection between the unsecured computing environment 208 and the secure crypto processing environment 100, but in detail those communications would occur through the receptacle on the wired smart phone 204c.

The secured conduit 218 is shown directly connection between the secured computing environment 206 and the secure crypto processing environment 100, but in detail those communications would occur through the receptacle on the wired smart phone 204c.

FIG. 2D illustrates a potential wireless cell phone embodiment 200d of the crypto wallet system 200 with a wireless smart phone 204d, a wireless crypto wallet 202d, a wireless unsecured conduit 216d, and a wireless secured conduit 218d.

The wireless smart phone 204d is an embodiment of the secure transaction authorization device 204. The wireless smart phone 204d is cellphone with shortrange wireless communication (for example Bluetooth or Wi-Fi or other short distance wireless communication technology).

The wireless crypto wallet 202d is an embodiment of the crypto wallet 202.

The wireless unsecured conduit 216d is shown directly connection between the unsecured computing environment 208 and the secure crypto processing environment 100, but in detail those communications would occur through the shortrange wireless communication technology on the wireless smart phone 204d.

The wireless secured conduit 218d is shown directly connection between the secured computing environment 206 and the secure crypto processing environment 100, but in detail those communications would occur through the shortrange wireless communication technology on the wireless smart phone 204d.

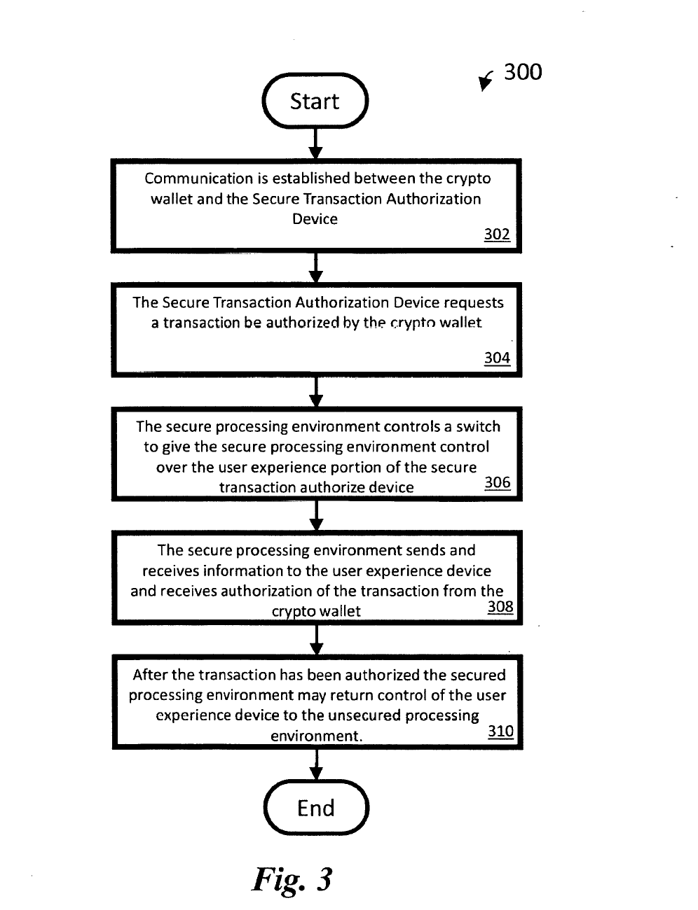

FIG. 3 illustrates a potential process flow 300 for the crypto wallet system 200.

The process flow 300 starts at box 302 where communication is established between the crypto wallet and the Secure Transaction Authorization Device

Next, the process flow 300 continues at box 304 where the Secure Transaction Authorization Device requests a transaction be authorized by the crypto wallet

Next, the process flow 300 continues at box 306 where the secure processing environment controls a switch to give the secure processing environment control over the user experience portion of the secure transaction authorize device.

Next, the process flow 300 continues at box 308 where the secure processing environment sends and receives information to the user experience device and receives authorization of the transaction from the crypto wallet.

Next, the process flow 300 continues at box 310 where after the transaction has been authorized the secured processing environment may return control of the user experience device to the unsecured processing environment. Then the process flow 300 ends.

What is claimed is:

1. A crypto hardware wallet comprising:
a smart card with a network computer interface, where the smart card:
receives a counterparty public key through the network computer interface;
computes a shared secret based on the received counterparty public key;
generates addresses specific to the counterparty based on the computed shared secret; and
signs transactions using the generated addresses.

2. The crypto hardware wallet of claim 1 where generating addresses specific to the counterparty comprises indexing the addresses based on the computed shared secret.

3. The crypto hardware wallet of claim 1 where the smart card obtains a BIP 47 identity through the network computer interface.

4. The crypto hardware wallet of claim 3 where the smart card processes transactions using the obtained BIP 47 identity.

5. The crypto hardware wallet of claim 1 where the smart card signs on-chain transactions.

6. The crypto hardware wallet of claim 5 where the smart card processes the on-chain transactions according to Open Bitcoin Privacy Project version five.

7. The crypto hardware wallet of claim 1 where the smart card signs off-chain transactions.

8. The crypto hardware wallet of claim 7 where the smart card processes the off-chain transactions using Open Transaction standards.

9. The crypto hardware wallet of claim 1 where the smart card selects a seed for computing the shared secret based on a card seed index received through the network computer interface.

10. The crypto hardware wallet of claim 9 where the smart card stores a plurality of independent seeds and the card seed index identifies which of the plurality of seeds to use for the shared secret computation.

11. A method for generating counterparty-specific cryptocurrency addresses, the method comprising:
receiving, at a smart card through a network computer interface, a counterparty public key;
computing, on the smart card, a shared secret based on the received counterparty public key;
generating, on the smart card, addresses specific to the counterparty based on the computed shared secret; and
signing, on the smart card, transactions using the generated addresses.

12. The method of claim 11 where generating addresses specific to the counterparty comprises indexing the addresses based on the computed shared secret.

13. The method of claim 11 further comprising obtaining a BIP 47 identity through the network computer interface.

14. The method of claim 13 further comprising processing transactions using the obtained BIP 47 identity.

15. The method of claim 11 where signing transactions comprises signing on-chain transactions.

16. The method of claim 15 where the on-chain transactions are processed according to Open Bitcoin Privacy Project version five.

17. The method of claim 11 where signing transactions comprises signing off-chain transactions.

18. The method of claim 17 where the off-chain transactions are processed using Open Transaction standards.

19. The method of claim 11 further comprising selecting a seed for computing the shared secret based on a card seed index received through the network computer interface.

20. The method of claim 19 where the smart card stores a plurality of independent seeds and the card seed index identifies which of the plurality of seeds to use for the shared secret computation.
